(19) United States
(12) Patent Application Publication
(10) Pub. No.: US 2002/0009214 A1
(43) Pub. Date: Jan. 24, 2002

(54) Virtual cosmetic surgery system

(76) Inventors: Ryoji Arima, Tokyo (JP); Hitoshi Fujimoto, Tokyo (JP); Masatoshi Kameyama, Tokyo (JP)

Correspondence Address: BIRCH STEWART KOLASCH & BIRCH, PO BOX 747, FALLS CHURCH, VA, 22040-0747, US

(21) Appl. No.: 09/858,629

(22) Filed: May 17, 2001

(30) Foreign Application Priority Data
Jul. 24, 2000 (JP) 2000-221864
Nov. 29, 2000 (JP) 2000-363032

(51) Int. Cl. G06K 9/00

(52) U.S. Cl. 382/128

(57) ABSTRACT

Conventional systems mainly include technical aspects and it is not a main purpose to display a changed result accurately. Therefore, its processing time is significantly long.

Thus, there are provided an image input device for inputting face data as digital data, an image output device for inputting change information on the face data and a terminal for storing a virtual cosmetic surgery program, extracting from the face data based on the change information a changing part including a feature part to be changed in predetermined manner and an absorbing part surrounding the feature part and absorbing a gap with respect to the periphery caused by a change and performing predetermined changing processing within the extracted changing part.

Accordingly, a changing person can obtain an image of his/her face changed partially in natural-looking manner.

This application is based on Application No. 2000-221864, filed in Japan on Jul. 24, 2000, and Application No. 2000-363032, filed in Japan on Nov. 29, 2000, the contents of which are hereby incorporated by reference.

### BACKGROUND OF THE INVENTION

1. Field of the Invention

The present invention relates to a virtual cosmetic surgery system for providing virtual cosmetic surgery services by using face images.

2. Description of the Related Art

Surgery on a face is performed in plastic or cosmetic surgeries. In such surgeries, it is almost common to show a virtual image after surgery by using some image processing. In that case, it is critical to create in the virtual image a customer's face after the surgery accurately. Thus, size, processing time and user interface of a processing program have been not so important in particular.

A conventional cosmetic surgery system will be described with reference to a drawing. FIG. 33 is a diagram showing a conventional cosmetic image system shown in Japanese Patent Publication No. (by PCT Application) 11-503540, for example.

In FIG. 33, a block 91 is a display screen of the system, and the block 92 is a tablet for operating the system.

Next, an operation of the conventional cosmetic surgery system will be described with reference to the drawing.

An operator may perform change with a higher degree of flexibility by dragging a “DRAW” menu on the screen 91 with the tablet 92 in order to enter into a change mode, specifying a part to be changed with a circle, set a free-hand mode within the circle with a device, not shown, and operating the tablet 92 properly.

Warping is used as a change method. Also, it is possible to drag the “DRAW” menu on the screen 91 in order to select a curved line drawing mode, draw an arbitrary curved line on the tablet 92, and apply it for changing a specified point of a reference image. The changed point is color-blended with a point before change, and then a changed image is created.

Thus, it is possible to achieve significantly accurate and precious change if the operator has enough knowledge on plastic surgery and understanding on operations of the system.

However, conventional cosmetic surgery systems mainly include technical aspects and it is not a main purpose to display a changed result accurately. Therefore, a problem raises that its processing time is significantly long.

Further, a system including a change program is very expensive and involves very complex operations. Therefore, a user must be skilled on the system.

In addition, if it is a cosmetic surgery system allowing easier operations, a part to be used for change is selected from data prepared by the system, and replaced by a part of a face image. That is, it does not change part data of the face image. As a result, processed image significantly different from an original image is obtained.

### SUMMARY OF THE INVENTION

The present invention was made in order to overcome the above-described problems. It is an object of the present invention to provide a virtual cosmetic surgery system for allowing anybody to perform virtual cosmetic surgery processing on a face image easily without special training, providing a natural-looking processed image by abstracting and changing part data in the face image, and further providing a service through network by transferring a virtual cosmetic surgery program and other information through network.

According to one aspect of the present invention, there is provided a virtual cosmetic surgery system including a face image input unit for inputting face image data, a change information input unit for inputting change information of the face image data, and a change processing unit for extracting from the face image data based on the change information a feature part selected as a part to be changed and an absorbing part surrounding the feature part, changing the feature part in predetermined manner and changing the absorbing part so as to absorb a gap with respect to the periphery caused by a change on the feature part.

In this case, the change information input unit may input a changing part in the face image data and its changing amount as the change information.

According to another aspect of the present invention, there is provided a virtual cosmetic surgery system, including a server for storing a virtual cosmetic surgery program, a face image data input unit for inputting face image data, a change information input unit for inputting change information of the face image data; and a processing terminal for executing the virtual cosmetic surgery program. The processing terminal extracts from the face image data based on the change information a feature part selected as a part to be changed and an absorbing part surrounding the feature part, changes the feature part in predetermined manner and changes the absorbing part so as to absorb a gap with respect to the periphery caused by a change on the feature part.

In this case, the processing terminal may perform a predetermined changing processing such as extension and/or rotation on the feature part of the changing part and perform changing processing on the absorbing part of the changing part so as to maintain the continuity of images in the feature part and its peripheral part in accordance with the feature part processing.

According to another aspect of the present invention, there is provided a virtual cosmetic surgery system, including a face image input unit for inputting face image data, a change information input unit for inputting change information on the face image data, a processing terminal for sending the face image data input by the face image input unit and the change information input unit and its change information, and a server for receiving through network the face image data and its change information sent by the processing terminal. The server extracts from the face image data based on the change information a feature part selected to be changed and an absorbing part surrounding the feature part, changes the feature part in predetermined manner and changes the absorbing part so as a part to absorb a gap with respect to the periphery caused by a change of the feature part.

In this case, the server may perform a predetermined changing processing such as extension and/or rotation on the feature part of the changing part and perform changing processing on the absorbing part of the changing part so as to maintain the continuity of images in the feature part and its peripheral part in accordance with the feature part processing.

Preferably, the server has a charging processing section for performing charging in predetermined manner when data is exchanged through the network.

The processing terminal may have a first data compressing/extending section for compressing/extending data exchanged through the network and the server may have a second data compressing/extending section for compressing/extending data exchanged through the network.

The processing terminal may have a first data encoding/decoding section for encoding/decoding data exchanged through the network and the server may have a second data encoding/decoding section for encoding/decoding data exchanged through the network.

According to another aspect of the present invention, there is provided a virtual cosmetic surgery system for extracting from the face image data a feature part selected as a part to be changed and an absorbing part surrounding the feature part, changing the feature part in predetermined manner and changing the absorbing part so as to absorb a gap with respect to the periphery caused by a change on the feature part.

In this case, when a part to be changed such as eye and nose are specified with a point, a rectangular area including this point may be extracted as the feature part and a rectangular area surrounding the feature part may be extracted as the absorbing part.

Preferably, the absorbing part smoothes a distortion caused by a change on the feature part through coordinate conversion by using two-dimensional interpolation.

According to the present invention, an image can be obtained in which a part of his/her face is changed naturally.

### BRIEF DESCRIPTION OF THE DRAWINGS

FIG. 1 is a block diagram showing an arrangement of a virtual cosmetic surgery system according to a first embodiment of the present invention;

FIG. 2 is a diagram showing screen transition of a virtual cosmetic surgery system according to a first embodiment of the present invention;

FIG. 3 is a diagram showing a system start screen of a virtual cosmetic surgery system according to a first embodiment of the present invention;

FIG. 4 is a diagram showing a face data input screen of a virtual cosmetic surgery system according to a first embodiment of the present invention;

FIG. 5 is a diagram showing a feature point input screen of a virtual cosmetic surgery system according to a first embodiment of the present invention;

FIG. 6 is a flow chart showing one example of processing for identifying a part a changing person specifies in a virtual cosmetic surgery system according to a first embodiment of the present invention;

FIG. 7 is a flow chart showing processing operations in detail for a step 100 in FIG. 6;

FIG. 8 is a flow chart showing processing operations in detail for a step 200 in FIG. 6;

FIG. 9 is a flow chart showing processing operations in detail for a step 300 in FIG. 6;

FIG. 10 is a flow chart showing processing operations in detail for a step 400 in FIG. 6;

FIG. 11 is a flow chart showing processing operations in detail for a step 500 in FIG. 6;

FIG. 12 is a flow chart showing processing operations in detail for a step 600 in FIG. 6;

FIG. 13 is a flow chart showing processing operations in detail for a step 700 in FIG. 6;

FIG. 14 is a diagram showing a virtual cosmetic surgery execution screen of a virtual cosmetic surgery system according to a first embodiment of the present invention;

FIG. 15 is a diagram showing a part data select/change execution screen of a virtual cosmetic surgery system according to a first embodiment of the present invention;

FIG. 16 is a changing part example of a virtual cosmetic surgery system according to a first embodiment of the present invention;

FIG. 17 is a flow chart showing processing for producing coordinates after changes in pixels of a feature part and an absorption part in a virtual cosmetic surgery system according to a first embodiment of the present invention;

FIG. 18 shows sequences of processing for producing coordinates after changes in pixels of a feature part and an absorption part in a virtual cosmetic surgery system according to a first embodiment of the present invention;

FIG. 19 is a flow chart showing one example of processing for obtaining color data of pixels in a virtual cosmetic surgery system according to a first embodiment of the present invention;

FIG. 20 is a flow chart showing one example of processing for obtaining color data of pixels in a virtual cosmetic surgery system according to a first embodiment of the present invention;

FIG. 21 is a diagram showing a concept for a pixel calculation according to processing in FIG. 19;

FIG. 22 is an example of a changing part changed by a virtual cosmetic surgery system according to a first embodiment of the present invention;

FIG. 23 is a diagram showing a changed result save screen of a virtual cosmetic surgery system according to a first embodiment of the present invention;

FIG. 24 is a block diagram showing an arrangement of a virtual cosmetic surgery system according to a second embodiment of the present invention;

FIG. 25 is a diagram showing screen transition of a virtual cosmetic surgery system according to a second embodiment of the present invention;

FIG. 26 is a diagram showing a charge confirmation screen of a virtual cosmetic surgery system according to a second embodiment of the present invention;

FIG. 27 is a diagram showing a charging screen of a virtual cosmetic surgery system according to a second embodiment of the present invention;

FIG. 28 is a block diagram showing an arrangement of a virtual cosmetic surgery system according to a third embodiment of the present invention;

FIG. 29 is a diagram showing screen transition of a virtual cosmetic surgery system according to a third embodiment of the present invention;

FIG. 30 is a diagram showing a system start screen of a virtual cosmetic surgery system according to a third embodiment of the present invention;

FIG. 31 is a diagram showing a face data input screen of a virtual cosmetic surgery system according to a third embodiment of the present invention;

FIG. 32 is a diagram showing a feature point input screen of a virtual cosmetic surgery system according to a third embodiment of the present invention; and

FIG. 33 is a diagram showing an arrangement of a conventional cosmetic surgery system.

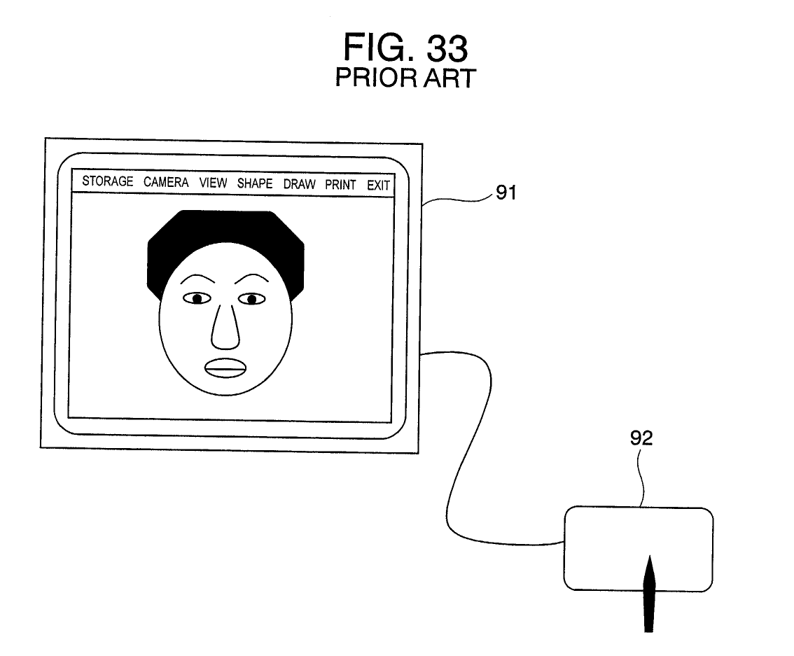

### DESCRIPTION OF THE PREFERRED EMBODIMENTS

First Embodiment

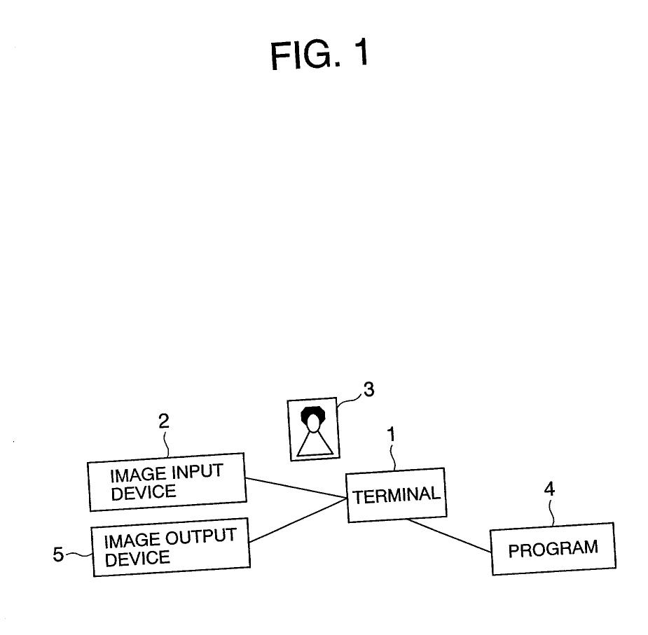

A virtual cosmetic surgery system according to a first embodiment of the present invention will be described with reference to drawings. FIG. 1 is a diagram showing a conceptual configuration of a virtual cosmetic surgery system according to a first embodiment of the present invention. In each of drawings, identical reference numerals are referred to identical or corresponding parts, respectively.

In FIG. 1, a block 1 is a terminal operated by a changing person and may be provided as a general-purpose machine such as a personal computer or may be a dedicated machine. A block 2 is an image input device for sending two-dimensional or three-dimensional face data as digital data to the terminal 1. A block 3 is two dimensional or three-dimensional face data obtained from the image input device 2 or prepared in advance. The face data 3 may include other parts in addition to a face part if a resolution of the face part reaches at a resolution required by a program. A block 4 is a program performing virtual cosmetic surgery on a face image. A block 5 is an image output device such as a display or a printer.

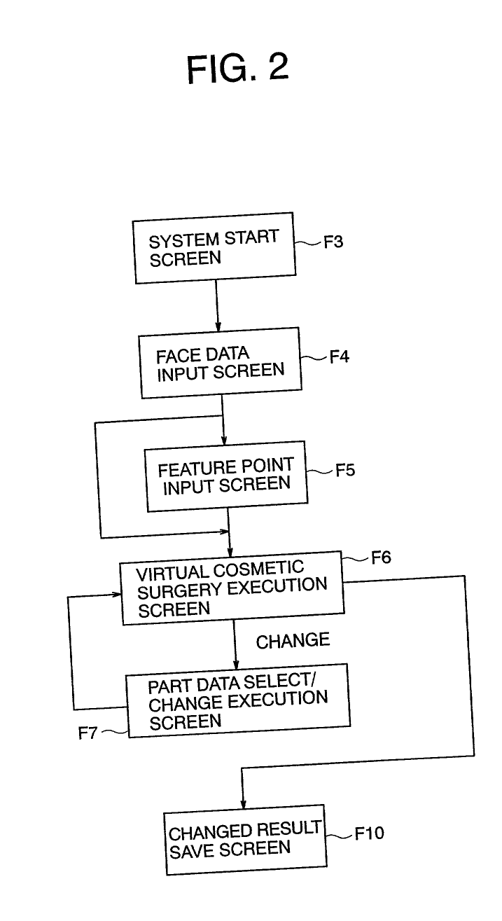

Next, an operation of the virtual cosmetic surgery system according to the first embodiment will be explained with reference to drawings. FIG. 2 is a diagram showing a screen transition in the virtual cosmetic surgery system according to the first embodiment of the present invention.

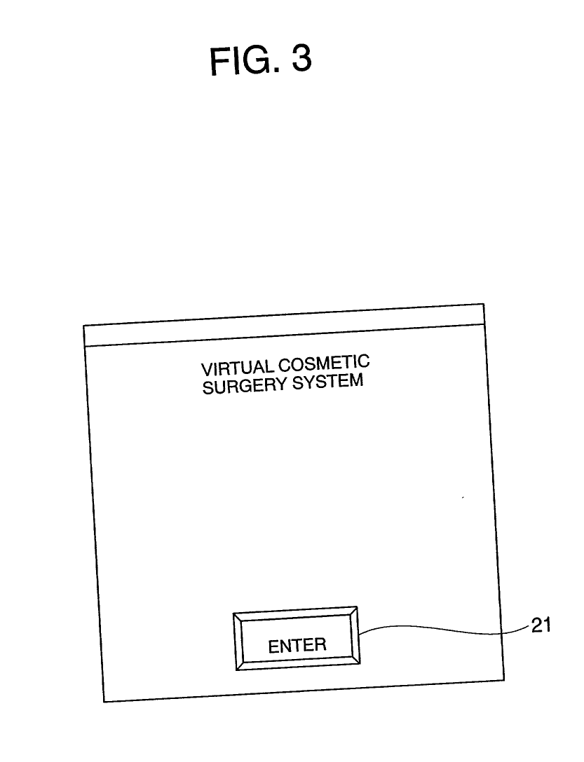

Reference numerals following Fs given to blocks in FIG. 2 are referred to figure numbers where blocks are described, respectively. For example, “F3” is described in FIG. 3. In FIG. 2, arrows are omitted for processing not given particularly in exemplified screens. However, basically, each screen may be arranged to go back in an opposite direction against the direction indicated by the arrows for easier use.

As shown in FIG. 2, the screen transition of the present system starts from a system start screen “F3”, through a face data input screen “F4”, a feature input screen “F5”, a virtual cosmetic surgery execution screen “F6”, and a part data select/change execution screen “F7” and terminates at a change result saving screen “FlO”.

A changing person starts up the program 4 on the terminal 1. FIG. 3 shows one example of a start-up screen, which is the system start screen “F3”. In FIG. 3, the changing person is asked whether or not he/she is going to use the virtual cosmetic surgery system. The changing person can indicate his/her to use the system by pressing an “ENTER” button 21. Once the program 4 receives a signal caused by the “ENTER” button 21, it goes to a virtual cosmetic surgery preparation screen.

Here, the “pressing” activity in embodiments of the present invention is referred to using a mouse or another screen manipulator moving device in order to locate a screen indicator such as a cursor at some area on the screen and clock there with a mouse or the like, or pressing a return key or enter key of a keyboard or pressing a physical button in order to ask for an operation request to the area.

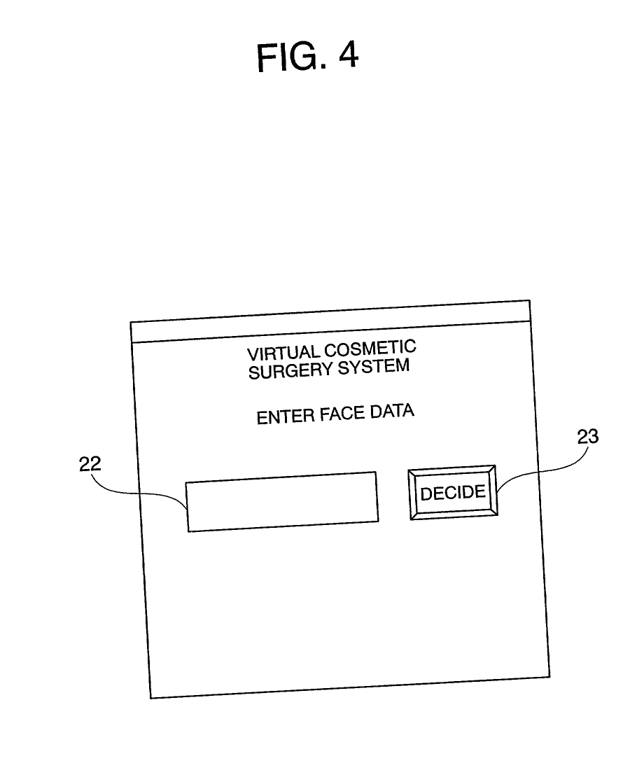

Next, the changing person causes the program 4 to read his/her face data. FIG. 4 shows one example of a face data read screen. The face data 3 is desirably digital data. The face data 3 is specified with a file name as a digital data file.

The file may be prepared in advance or may be input through the image input device 2. When the image input device 2 is used, a dedicated utility program may be prepared in advance so that digital data obtained through the image input device 2 is read by the program 4 automatically. A file format of the face data 3 may be any format the program 4 can understand.

In FIG. 4, a block 22 is an input region for inputting a file name of an image, and a block 23 is a face data reading start button (“DECIDE” button). When the “DECIDE” button 23 is pressed, the program 4 read the face data 3 specified at the input region 22.

The program 4 extracts based on the read face data 3 a changing part including a feature part to be changed in predetermined manner and an absorbing part surrounding the feature part and absorbing a gap with respect to the periphery caused by a change. The extraction desirably can be done automatically within the program 4. However, if the processing takes a long time or accurate extraction is not possible, the feature part may be specified by the changing person.

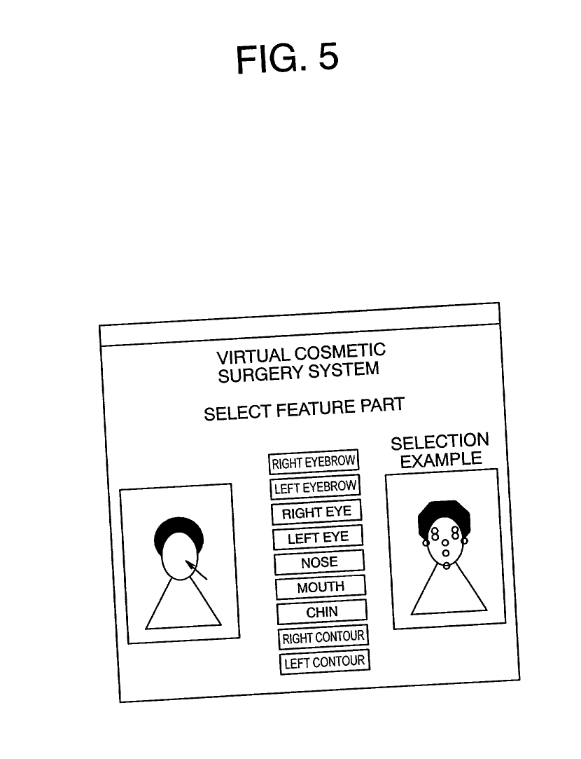

FIG. 5 shows one example of a screen where the changing person is asked to specify a feature part. FIG. 5 shows a case where the changing person is asked to specify nine points including eyebrows and eyes. When the feature part is specified by the changing person, supplemental information is desirably given to the changing person so as to advice the changing person to specify the nearest point required by the program 4 as much as possible.

In order to extract a feature part and a changing part, first of all, it is identified which part a specified point (called feature point) specifies and then predetermined feature and absorption parts for the specified part are extracted by using the feature point as a reference.

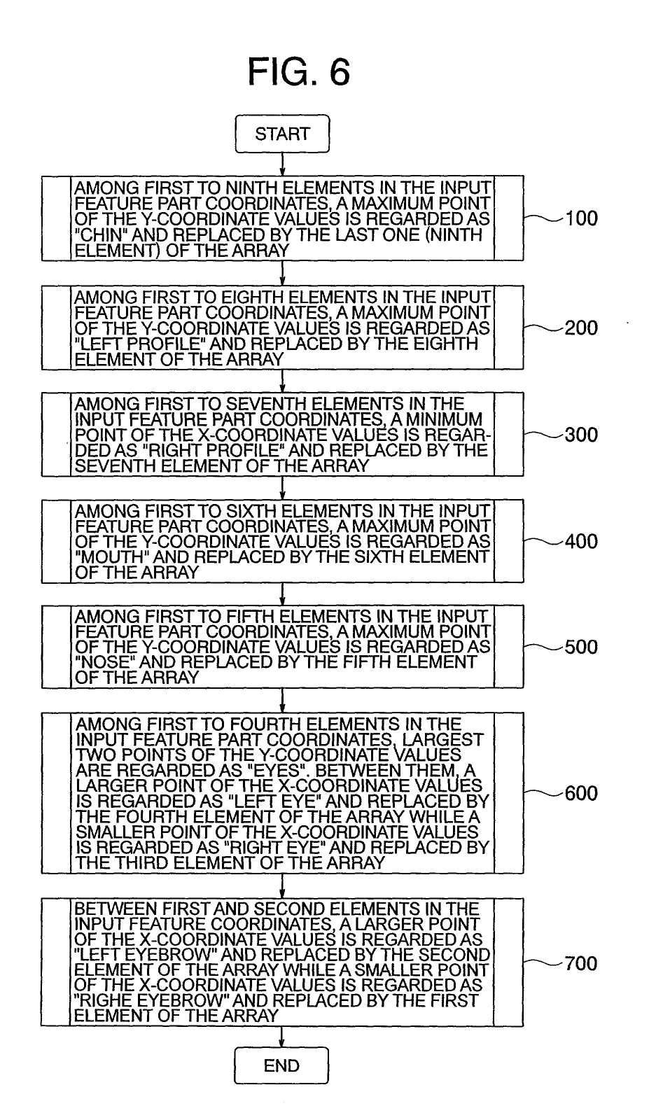

FIG. 6 is a flow chart showing one example of processing for identifying which points refer to which parts, respectively when a changing person specifies total 9 points including both eye brows, both eyes, mouth, chin and both profiles (program 4).

As coordinate values for feature parts input by the changing person in arbitrary orders, X-coordinates and Y-coordinates are stored in an array posx[9] and an array posy[9], respectively. In this coordinate system, an origin is at upper left and positive ranges are the right direction in X-axis and the down direction in Y-axis. It should be noted that right and left of the face on the image are opposite to those of the actual face since this image is imaged from the front.

In a step 100, among first to ninth elements in the input feature part coordinates, a maximum point of the Y-coordinate values is regarded as “chin” and replaced with the last one (ninth element) of the array.

In a step 200, among first to eighth elements in the input feature part coordinates, a maximum point of the Y-coordinate values is regarded as “left profile” and replaced with the eighth element of the array.

In a step 300, among first to seventh elements in the input feature part coordinates, a minimum point of the X-coordinate values is regarded as “right profile” and replaced with the seventh element of the array.

In a step 400, among first to sixth elements in the input feature part coordinates, a maximum point of the Y-coordinate values is regarded as “mouth” and replaced with the sixth element of the array.

In a step 500, among first to fifth elements in the input feature part coordinates, a maximum point of the Y-coordinate values is regarded as “nose” and replaced with the fifth element of the array.

In a step 600, among first to fourth elements in the input feature part coordinates, largest two points of the Y-coordinate values are regarded as “eyes”. Between them, a larger point of the X-coordinate values is regarded as “left eye” and replaced with the fourth element of the array while a smaller point of the X-coordinate values is regarded as “right eye” and replaced with the third element of the array.

In step 700, between first to second elements in the input feature coordinates, a larger point of the X-coordinate values is regarded as “left eyebrow” and replaced with the second element of the array while a smaller point of the X-coordinate values is regarded as “right eyebrow” and replaced with the first element of the array.

Through the above-described processes, the elements of the array are rearranged in order corresponding to “right eyebrow”, “left eyebrow”, “right eye”, “left eye”, “nose”, “mouth”, “right profile”, “left profile” and “chin”.

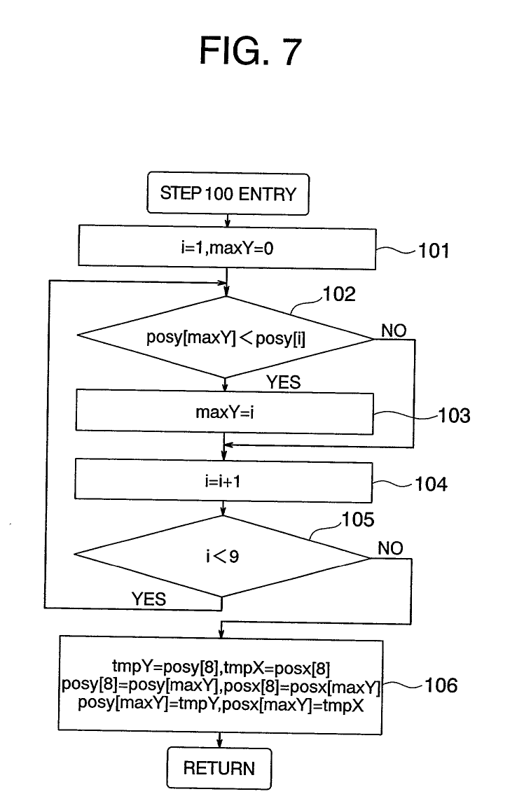

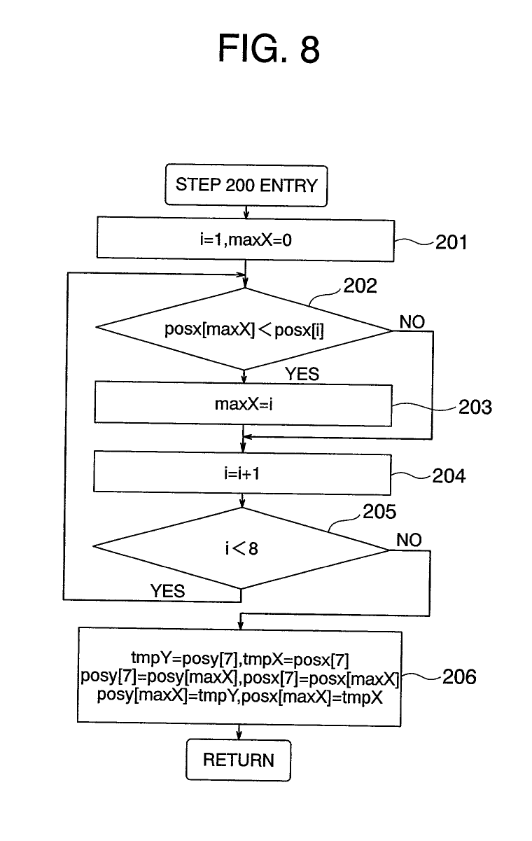

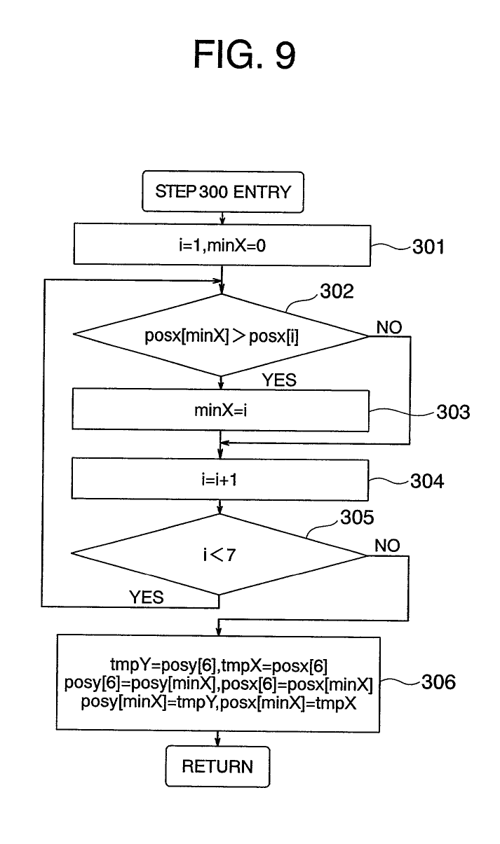

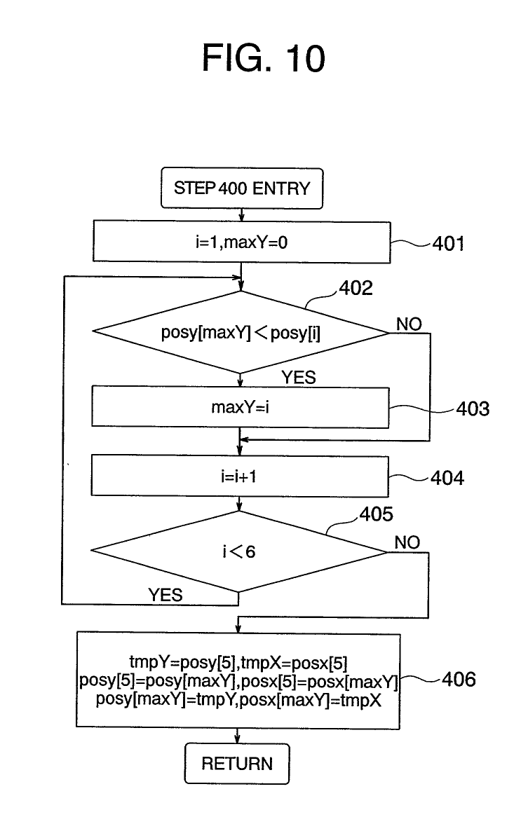

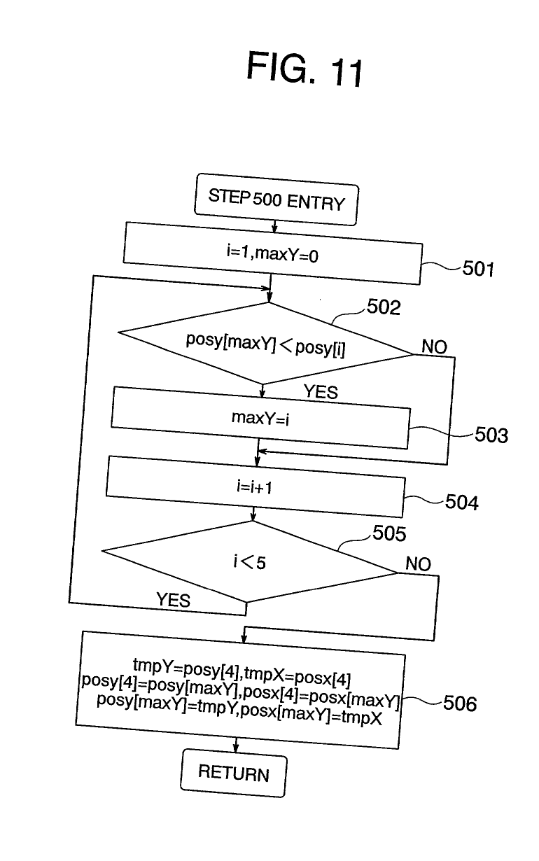

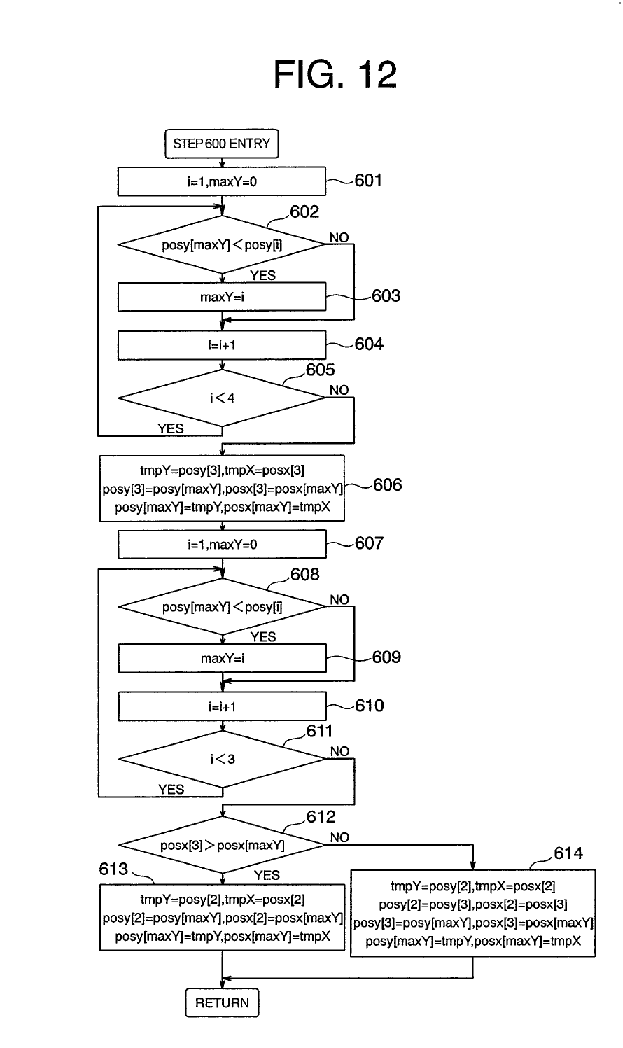

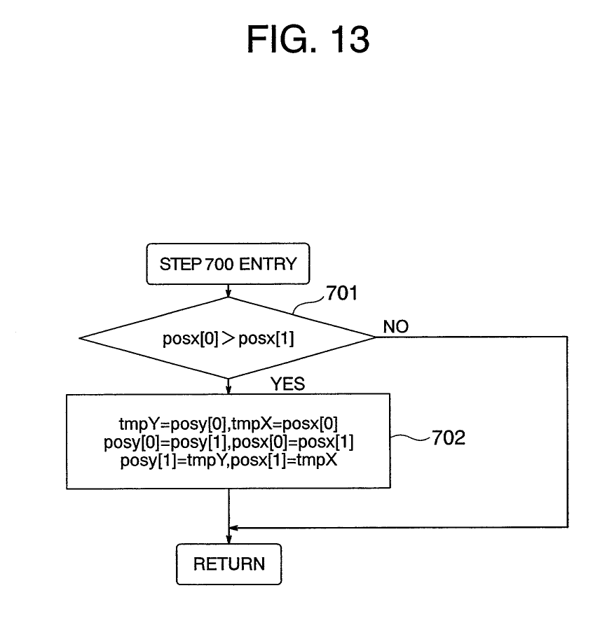

FIGS. 7, 8, 9, 10, 11, 12 and 13 are flow charts showing processing in detail for steps 100, 200, 300, 400, 500, 600 and 700.

The feature part extracted in FIG. 6 includes eyes, mouth, nose and so on of 90% people when faces of females in tens and twenties are standardized based on a distance between both eyes.

While the feature point specification processing differs depending on specified points, it can be performed by changing the processing in FIG. 6 in simple manner for the parts shown in FIG. 6. For example, when a mouth is specified, the step 400 may be performed after the determination in the step 100 if a chin has been specified. Alternatively, if a chin has not been specified, the determination in the step 400 may be performed directly. Even parts which have not been specified in FIG. 6 may be specified by application of the processing in FIG. 6. For example, when ears are specified, the steps 200 and 300 are used for the specification of the ear and then left and right profiles may be again specified by performing the steps 200 and 300.

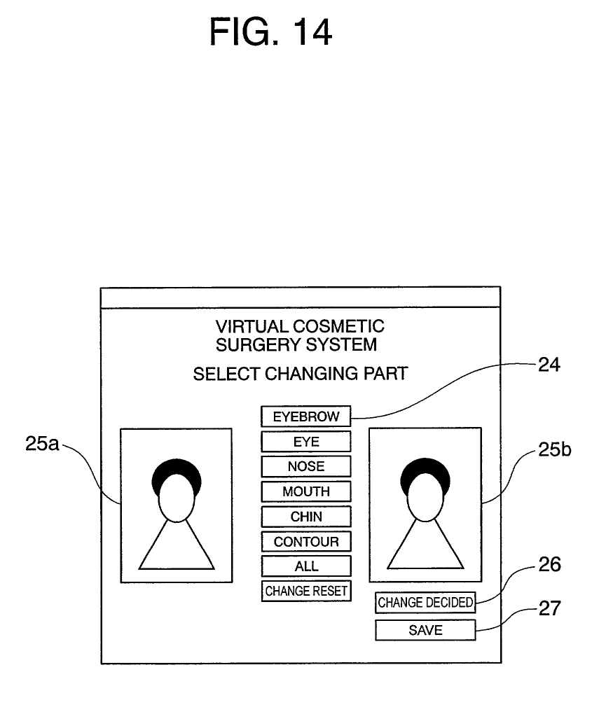

Next, the program 4 asks change information to the changing person. FIG. 14 shows one example of a changing part select screen. In FIG. 14, a block 24 is a “changing part specify” button and having a plurality of buttons including “EYEBROW”, “EYE”, “NOSE”, “MOUTH”, “CHIN” buttons for respective parts. Preferably, an “ALL” button indicating total changes is provided for changing all of each part data based on a certain rule so that the changing person can carry out total virtual cosmetic surgery easily. Further, a “CHANGE RESET” button is desirably provided for changing all of changes back to a first image.

In FIG. 14, blocks 25a and 25b are display areas of changing person face data. The display area 25a always displays face data 3 before change. The display area 25b is where a change result is reflected. The change result may be displayed on the display area 25b for every specification of change on each part. Alternatively, if a “CHANGE DECIDED” button 26 is prepared, all of changes may be performed at one time when the “CHANGE DECIDED” button 26 is pressed, and then the change result may be displayed. Face data may be displayed only with an image after change. However, it is desirable that both face data before and after change are displayed in parallel so that the changing person can realize effects by the change easily.

Further, in FIG. 14, a block 27 is a “SAVE” button of a change image. The changing person selects a part that he/she needs to change on his/her face and presses corresponding buttons in “changing part specify” button 24. Then, a decide screen for an amount of changing a select part is displayed. The changing amount decide screen may be within a same window. Alternatively, another window may be created to display the screen.

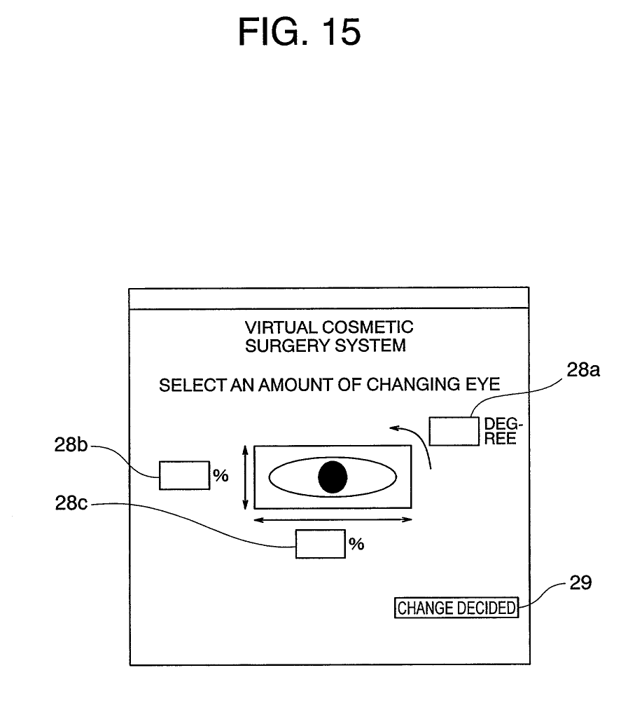

FIG. 15 shows one example of a decide screen of an amount of changing an eye. The changing person inputs an angle, a longitudinal extension ratio and a lateral extension ratio in input regions 28a, 28b and 28c, respectively, in order to determine a changing amount and then press a “CHANGE DECIDED” button 29. Similarly, the changing person decides changing amounts for parts which can be changed such as nose and mouth.

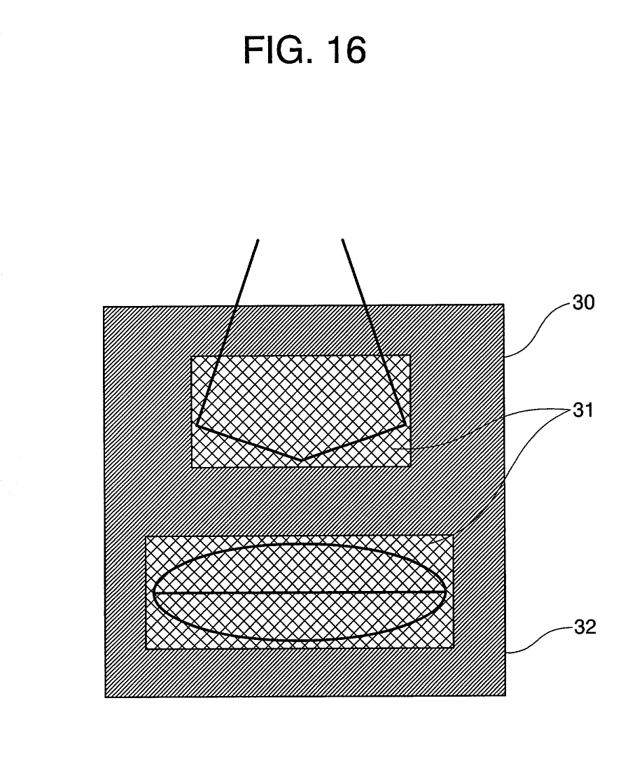

Next, the program 4 changes an image based on changing information. FIG. 16 shows an example of changing part. In FIG. 16, a block 30 is a changing part, which includes a feature part 31 and an absorbing part surrounding the feature part. As shown, the changing part 30 may include a plurality of feature parts 31. Changes determined by the changing person are applied to the feature parts. A change is applied to the absorbing part 32 such that a part between the feature part 31 and the periphery of the absorbing part 32 does not look unnatural while keeping information on the periphery of the absorbing part 32.

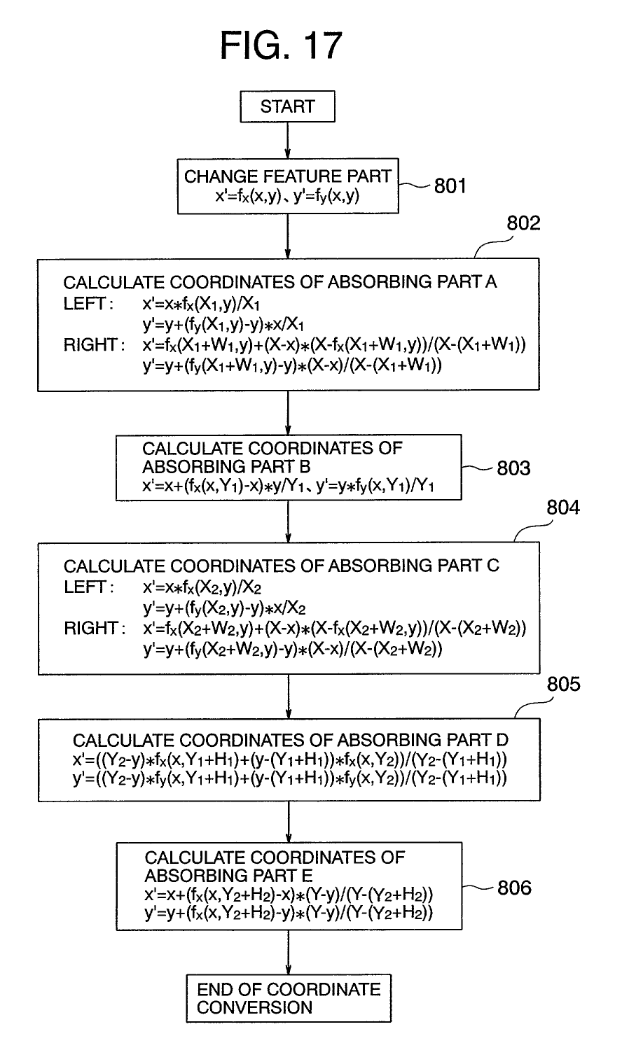

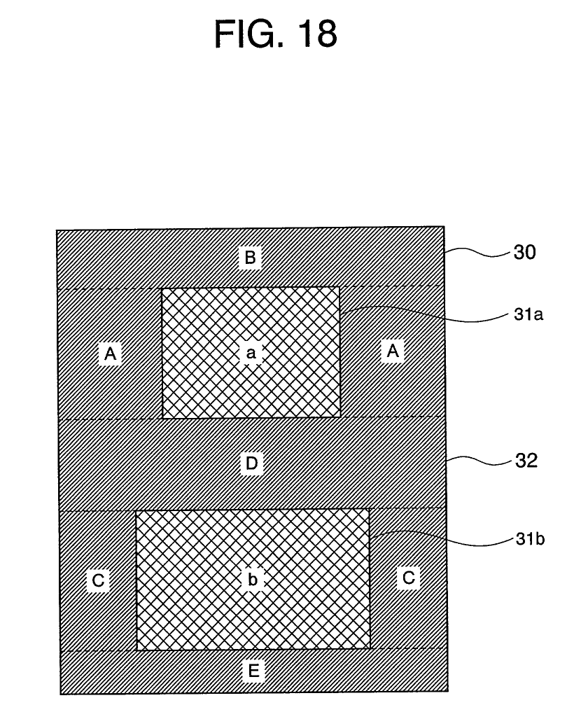

Next, an example is shown for a case where a feature part is interpolated two-dimensionally in an absorbing area. FIG. 17 is a flow chart showing processing for producing coordinates after changing pixels of a feature part and an absorbing part. FIG. 18 is a diagram showing processing sequences thereof.

FIG. 18 shows a case where two feature parts are aligned vertically in a changing part in the same manner as FIG. 16. In FIG. 18, 31a, 31b, and 32 are referred to feature part a, feature part b and absorbing parts A, B, C. D and E, respectively. It is assumed that a width and a height of a rectangle in the extracted changing part 30 are X+1 and Y+1, respectively. Further, it is assumed that the upper left coordinates of the rectangle is (0,0). Still further, it is assumed that upper left coordinates, a width and a height of the feature part 31a and 31b are (Xn, Yn), Wn+1 and Hn+1 (where n=1,2). There is pixels for face data in a point (i,j) (where i=0 to X, and j=0 to Y) within the changing part 30 and may be represented by RGB three colors, for example.

In step 801, the feature parts a and b are changed. x and y in the step 801 are referred to arbitrary pixels included in the feature parts a and b. This changing operation is based on what a changing person specifies). Thus, coordinates of the pixels of the feature parts a and b are converted to (X′, y′).

Next, In step 802, coordinates of the pixels in the absorbing part A in FIG. 18 are converted. In the left side of the absorbing part A in FIG, 18, pixels of the absorbing part A are rearranged at even intervals between coordinates of a left edge of the changed feature part 31a and a left edge of the changing part 30. Similarly, in the right side of the absorbing part A, pixels of the absorbing part A are rearranged at even intervals between coordinates of a right edge of the changed feature part a and a right edge of the changing part 30. In these rearrangements, y coordinate of the absorbing part A edge and the unchanged y coordinate of the changing part 30 edge have to be the same.

Next, in step 803, coordinates of pixels of the absorbing part B in FIG. 18 are converted. The pixels of the absorbing part B are rearranged at even intervals between coordinate of the upper edge of the feature part a and the absorbing part A and the upper edge of the changing part 30. The absorbing part A has been changed already in step 802 because it has the same y coordinate as one of the unchanged upper edge of the changing part 30, which can be used here. In these rearrangements, x coordinate of the upper edge of the changing part 30 and the unchanged x coordinate of the upper edges of the changing part 30 and the absorbing part A have to be the same.

Next, in step 804, coordinates of pixels of the absorbing part C in FIG. 18 are converted. The same conversion method is used as in step 802.

Next, in step 805, coordinates of pixels of the absorbing part D in FIG. 18 are converted. The pixels of the absorbing part D are rearranged at even intervals between the lower edges of the feature part a and the absorbing part A and the upper edges of the feature part b and the absorbing part C. The absorbing part A has been changed already in step 802 because it has the same y coordinate as one of the unchanged lower edge of the feature part a, which can be used here. Further, the absorbing part C has been changed already in step 804 because it has the same y coordinate as one of the unchanged upper edge of the feature part b, which can be used here. In these rearrangements, unchanged x coordinates at both edges have to be the same.

Next, in step 806, coordinates of pixels of the absorbing part E in FIG. 18 are converted. The pixels of the absorbing part E are rearranged at even intervals between the lower edges of the feature part b and the absorbing part C and the lower edges of changing part 30. The absorbing part C has been changed already in step 804 because it has the same y coordinate as one of the unchanged lower edge of the feature part b, which can be used here. In these rearrangements, the x coordinate of the lower edge of the changing part 30 and the unchanged x coordinate of the lower edge of the absorbing part E have to be the same.

Through the above-described processing, coordinates of the feature part 31 and the absorbing part 32 are converted in relation to the changes. While this embodiment describes the case where two feature parts 31 are aligned vertically in the changing part 30, steps 804 and 805 are omitted when only one feature part 31 exists in the changing part 30.

In most cases, the coordinates after coordinate conversions are not integer values except for those of upper, lower, left and right edges of the absorbing area. However, pixels cannot be recorded only at each of x, y integer points. Thus, it is required to calculate color data of a place where x and y are integer values.

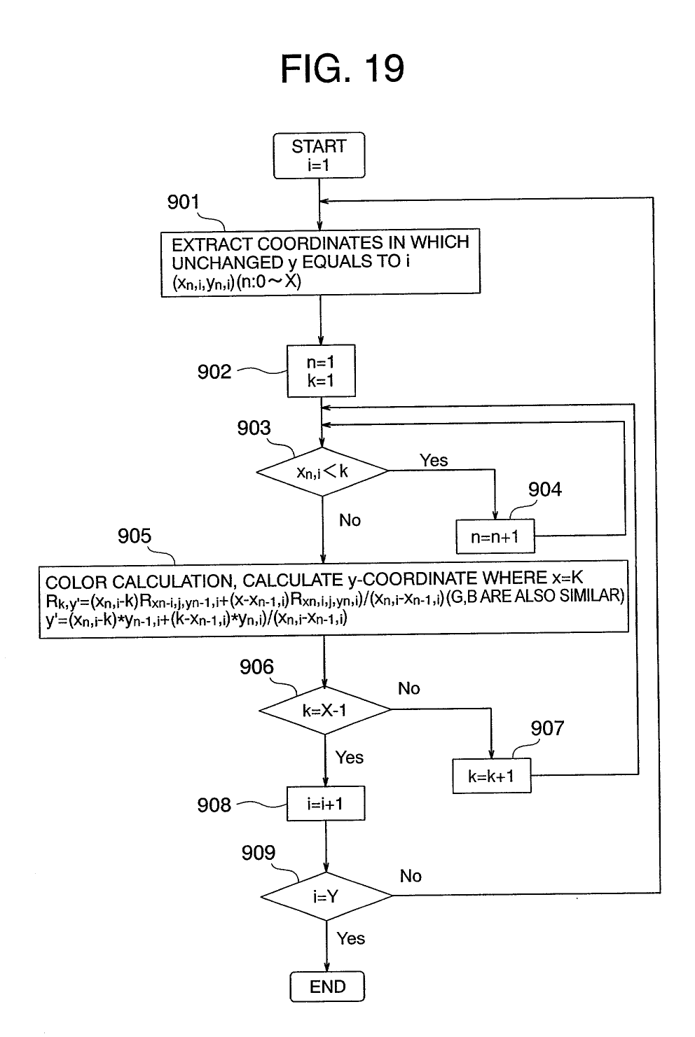

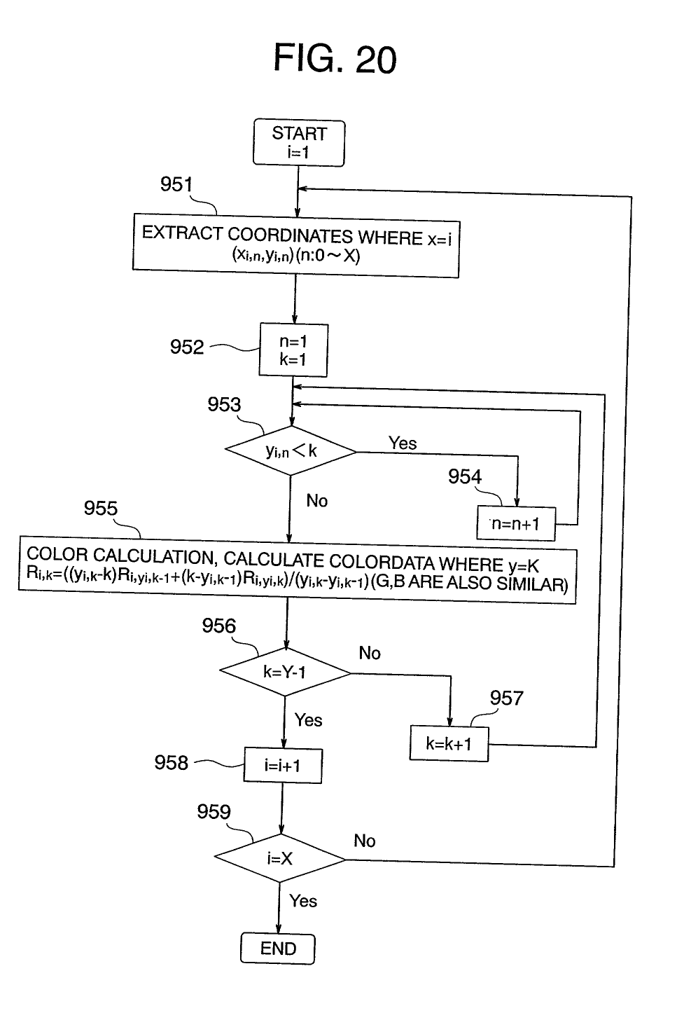

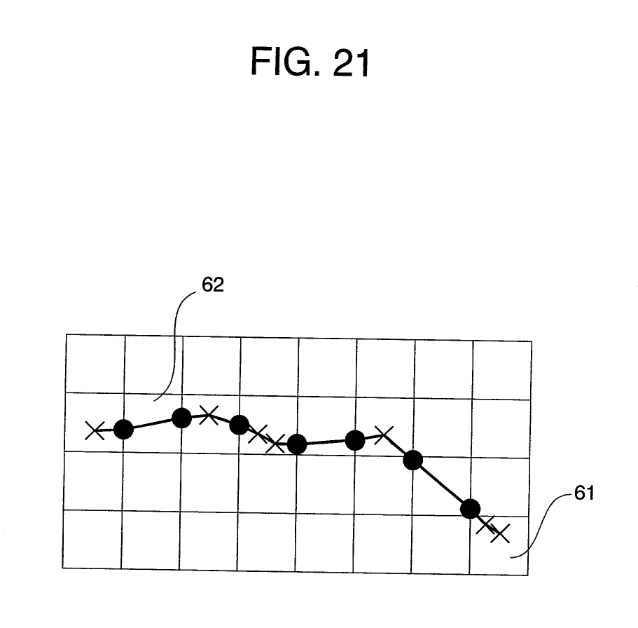

FIGS. 19 and 20 are flowcharts for showing examples of processing for obtaining color data of pixels. Further, FIG. 21 is a concept diagram for calculating pixels through processing in FIG. 19. In FIG. 21, 61 and 62 are referred to a position of pixels before the processing in FIG. 19 is performed and a position of pixels after the processing in FIG. 19 is performed, respectively. Through processing shown in the flow chart in FIG. 19, color data of coordinates whose x value is an integer value can be generated. However, since its y coordinate is not always an integer value, color data at a position where the y coordinate is an integer value can be generated through the processing shown in the flow chart in FIG. 20, which can be final output image data.

As seen from the above described coordinate conversion and color calculation, image data at upper, lower, left and right edges of the changing part 30 do not change. Further, unchanged pixels do not inverted in up, down, right and left directions, which maintains the continuity of the image. Thus, unnatural profiles and/or image distortions are not found even after the changing operations.

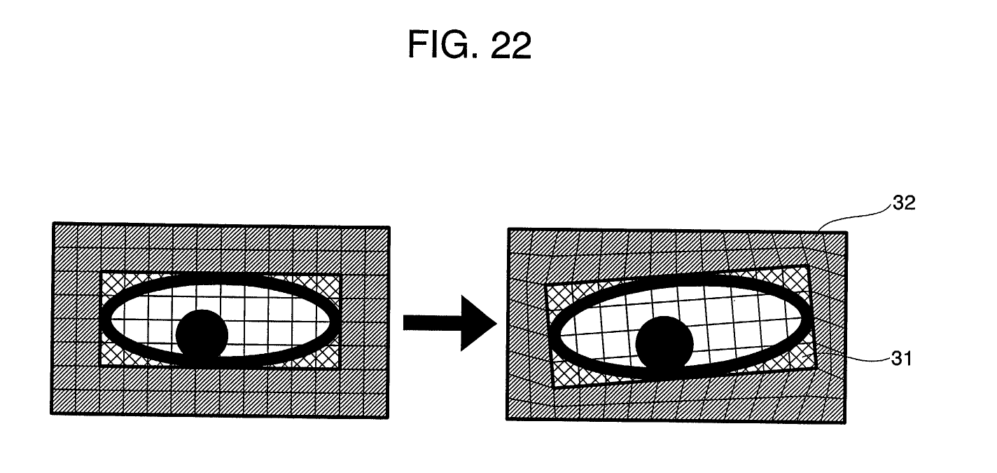

FIG. 22 shows an example of a change in the changing part 30. IN FIG. 22, the absorbing part 32 applies a two-dimensional linear interpolation on the feature part 31. However, the method of interpolation may be selected properly in accordance with a processing time and/or required image quality without any limitation. The image after the change is displayed on the display area 25b shown in FIG. 14. However, if the changing parson is not satisfied with a changing result, the change can be continued or changed immediately. Operation for that is the same as the first changing operation.

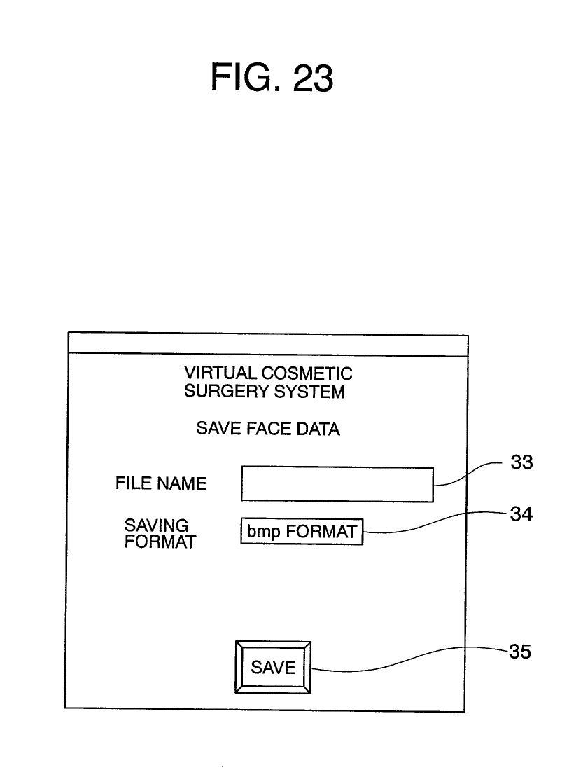

Once the changing person completes changes, the “SAVE” button 27 is pressed if he/she needs to save the image after the changes on the display area 25b. FIG. 23 show one example of a changed image saving screen. In FIG. 23, a block 33 is an input field for inputting a storage place. A block 34 is an input field for selectively input a saving file format, and a block 35 is a “SAVE” button for starting saving.

The changing person selects and inputs a saving place and a saving file format in the input fields 33 and 34 and then presses the “SAVE” button 35. Then, saving the changed image is completed. The saving file format may be fixed to a general file format such as bit map file (bmp). However, it is desirable that a plurality of general file formats can be selected in view of convenience of the changing person.

In each of screens in FIGS. 4, 5, 14, 15, 16, 22, 23, it is possible that a “HELP” button, not shown, for supplying information aiding operations by the changing person is provided so that the changing person can be provided with information helping changing person's operations in each of screens by pressing the button.

According to the arrangement as above, the changing person can obtain an image where his/her face data is changed in natural-looking manner partially by operating the virtual cosmetic surgery system.

Second Embodiment

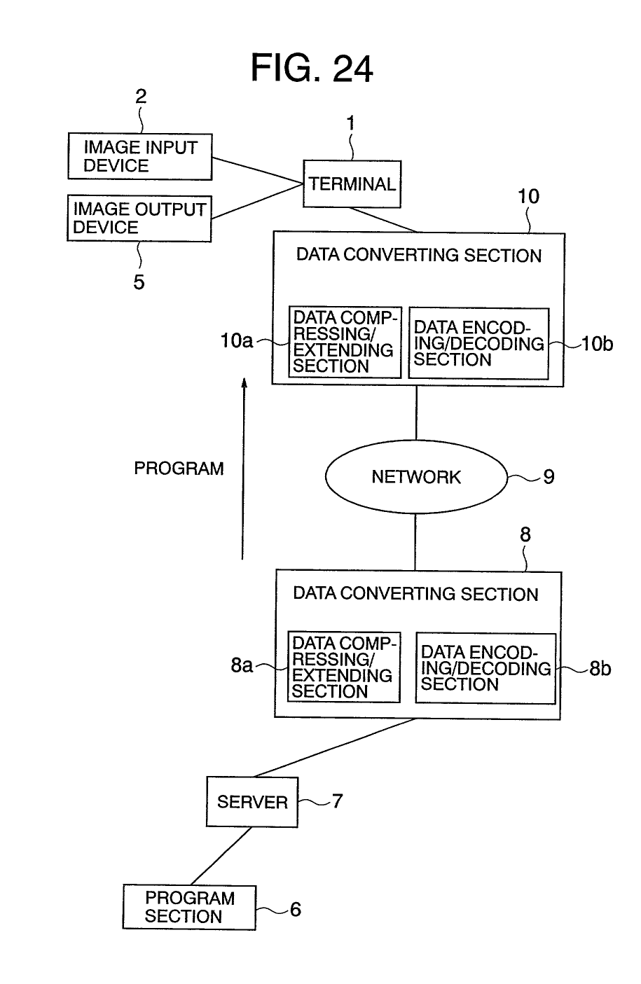

A virtual cosmetic surgery system according to a second embodiment of the present invention will be described with reference to drawings. FIG. 24 is a diagram showing a configuration of the virtual cosmetic surgery system according to the present invention.

In FIG. 24, a block 7 is a server for connecting to a terminal 1 though network 9 such as a telephone line. The server 7 includes a program section 6 for virtual cosmetic changes. Further, the server 7 has a data converting section 8 including a data compressing/extending section 8a and a data encoding/decoding section 8b. Furthermore, the terminal 1 has a data converting portion 10 including a data compressing/extending section 10b and a data encoding/decoding portion 10b.

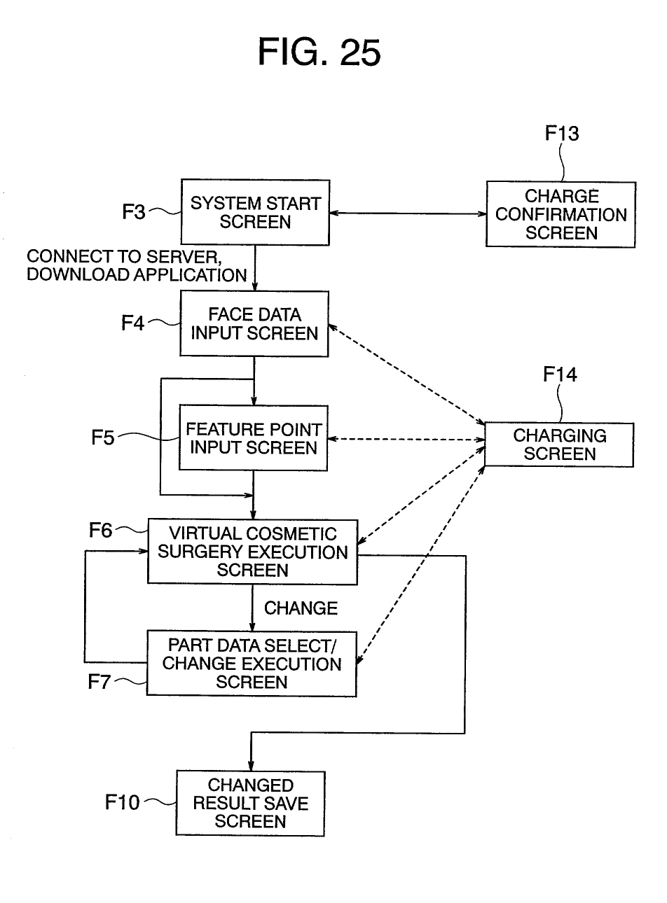

Next, an operation of the virtual cosmetic surgery system according to the second embodiment of the present invention will be described with reference to drawings. FIG. 25 is a diagram showing screen transition of the virtual cosmetic surgery system according to the second embodiment of the present invention.

Reference numerals following Fs given to blocks in FIG. 25 are referred to figure numbers where blocks are described, respectively. Dashed-line arrows are applicable for the case where charging information is used. In FIG. 25, arrows are omitted for processing not given particularly in exemplified screens. However, basically, each screen may be arranged to go back in an opposite direction against the direction indicated by the arrows for easier use.

A changing person uses the terminal 1 to connect to the server 7 and downloads the program section 6 of the virtual cosmetic surgery system. As a connection method, a private line may be used or Internet may be used through a telephone line. The download method may use a general network browser or may start up a system inherent to the terminal 1 side in order to connect to the server 7 with an inherent protocol. No limitation exists in the connection method and the startup method.

For the second embodiment, a case where a general network browser is used in order to down load the program section 6, which is all of the present system. The program section 6 may be in any format, on which virtual cosmetic surgery processing is performed through the terminal 1. When the program section 6 is transferred from the server 7 to the terminal 1. Data is compressed and encoded as necessary in the data converting section 8 on the server side. The data is extended, decoded and reproduced in the data converting section 10 on the terminal 1 side.

The changing person operate the virtual cosmetic surgery system through the terminal 1. The program section 6 is downloaded from the server 7 and resides in the terminal 1. Thus, the operating method is the same as the first embodiment.

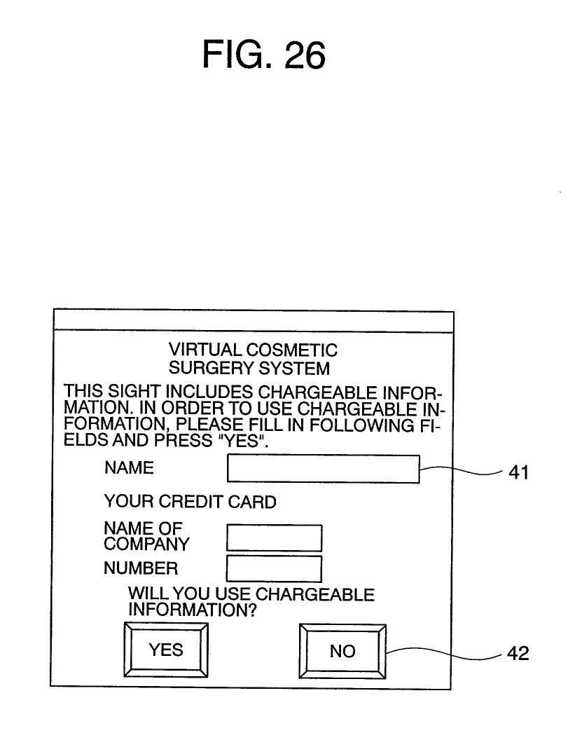

When the program section 6 or other chargeable information from the server 7 to the terminal 1, charging is also possible. FIG. 26 shows one example of a charge confirmation screen. In FIG. 26, blocks 41 are input fields for inputting a name of the changing person and charging information such as credit card information. The changing person inputs information used for being charged such as his/her name and/or credit card number. Types of the information are not limited in particular, but, at least, must be information by which the changing person can be identified and it can be confirmed if the changing person will pay for the charge.

In FIG. 26, a block 42 is a charge confirmation button. When the changing person presses a “YES” button, he/she is charged when the chargeable information is transferred from the server 7 to the terminal 1. On the other hand, the changing person presses a “NO” button, he/she cannot obtain the chargeable information.

When the changing person inputs the charging information and presses the “YES” button of the charge confirmation button 42, the charging information is transferred from the terminal 1 to the server 7. At the transfer process, the data is compressed and encoded by the data converting section 10 in the terminal 1 and the data is extended and decoded by the data converting section 8 in the server 7 for reproduction, as necessary. Thus, private information hardly leaks even when the data leaks.

At the charging process, an arrangement is desirable that the chargeable information can be identified by the changing person easily, and when he/she presses a button for requesting the chargeable information, that is when the “NO” button of the charge confirmation button 42 is pressed, the changing person is informed that the information is not available because it is chargeable while when the “YES” button is pressed, the changing person is informed of that he/she is charged in return for obtaining the chargeable information and the charged amount.

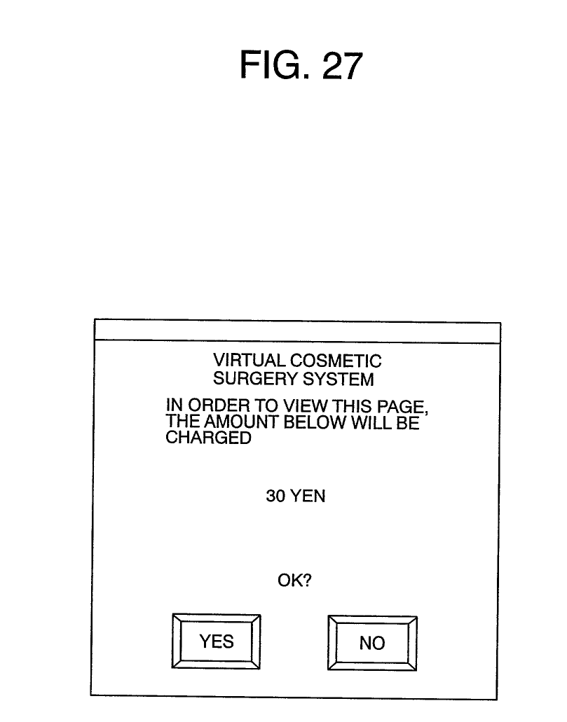

FIG. 27 shows one example of a charging screen in the present system. The screen is displayed only when the changing person uses the chargeable information. The changing person checks the charge and if he/she wishes to pay, he/she presses “YES”. On the other hand, if he/she does not have an intention to pay, he/she presses the “NO” button. When the “YES” button is pressed, the screen goes to a chargeable information screen while when the “NO” button is pressed, the screen moves to a screen before selecting the chargeable information.

According to the arrangement as above, the changing person can obtain an image where a face is changed in natural-looking way partially by operating the virtual cosmetic surgery system.

Further, it is possible that the program of the virtual cosmetic surgery system is owned by the server 7 and is transferred as required. Thus, the virtual cosmetic surgery system can be used always without having so large load on the terminal 1. Further, making partial contents to be transferred chargeable and adopting a charging system allow charging corresponding to processing by the changing person.

In the second embodiment, encoding/decoding processing is performed on data when the data is transferred through the network 9. In that case, any encoding method can be used. However, changing the encoding method to another method for a certain period of time can prevent information leaks.

Further, when data is transferred from the terminal 1 to the server 7 or from the server 7 to the terminal 1, the load on the private line or Internet can be reduced by compressing data, which provides the changing person comfortable operation.

Third Embodiment

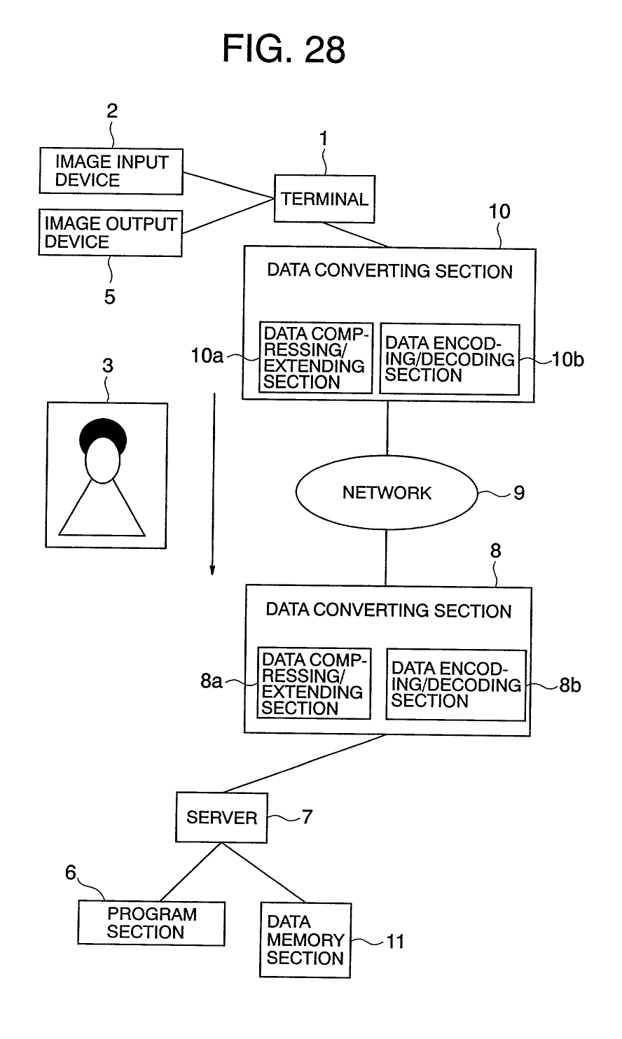

A virtual cosmetic surgery system according to a third embodiment of the present invention will be described with reference to a drawing. FIG. 28 is a diagram showing an arrangement of the virtual cosmetic surgery system according to the third embodiment of the present invention.

In FIG. 28, a block 7 is a server for connecting to a terminal 1 though network 9 such as a telephone line. The server 7 includes a program section 6 for virtual cosmetic changes and a data memory section 11 for storing face data 3 and other information sent from the terminal 1. Further, the server 7 has a data converting section 8 including a data compressing/extending section 8a and a data encoding/decoding section 8b. Furthermore, the terminal 1 has a data converting portion 10 including a data compressing/extending section 10b and a data encoding/decoding portion 10b.

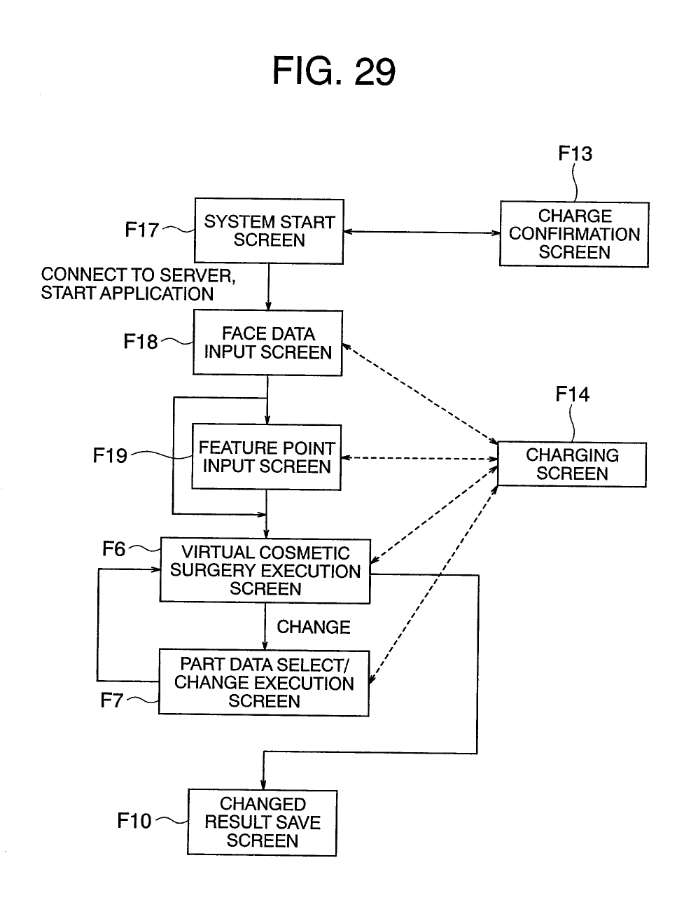

Next, an operation of the virtual cosmetic surgery system according to the third embodiment of the present invention will be described with reference to drawings. FIG. 29 is a diagram showing screen transition of the virtual cosmetic surgery system according to the third embodiment of the present invention.

Reference numerals following Fs given to blocks in FIG. 29 are referred to figure numbers where blocks are described, respectively. Dashed-line arrows are applicable for the case where charging information is used. In FIG. 29, arrows are omitted for processing not given particularly in exemplified screens. However, basically, each screen may be arranged to go back in an opposite direction against the direction indicated by the arrows for easier use.

A changing person uses the terminal 1 to start up the virtual cosmetic surgery system. As a connection method, a private line may be used or Internet may be used through a telephone line. The start-up method may use a general network browser to start up the system prepared in the server 7 or may start up a system inherent to the terminal 1 side in order to connect to the server 7 with an inherent protocol. No limitation exists in the connection method and the start-up method. In the third embodiment, a case is shown where a general network browser is used to start up the present system prepared in the server 7. A least necessary content for operating the present system is transferred from the server 7 to the terminal 1.

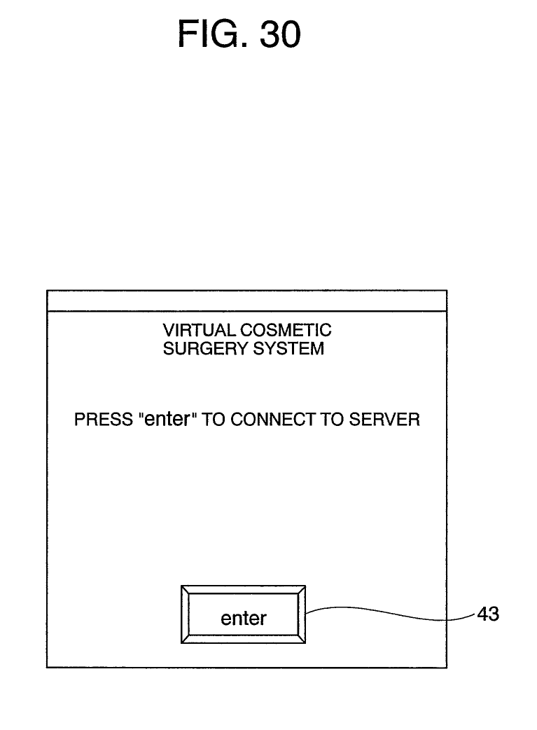

FIG. 30 shows one example of a start-up screen. The terminal 1 asks the changing person whether or not he/she is going to use the virtual cosmetic surgery system. The changing person can indicate his/her to use the system by pressing an “enter” button 43. Once the terminal 1 and the server 7 receive a signal caused by the “ENTER” button 43, they start to share the system.

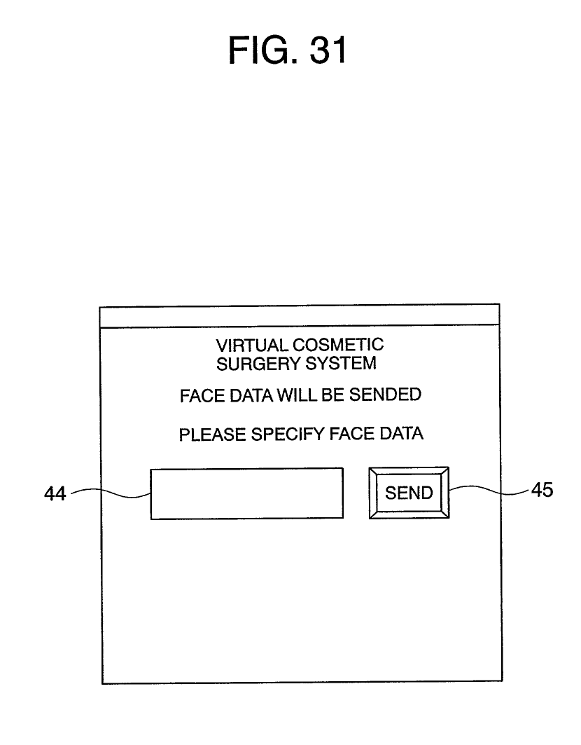

Next, the changing person transfers his/her face data from the terminal 1 to the server 7 through the network 9. FIG. 31 shows one example of a face data specify screen. The face data 3 is desirably digital data. The face data 3 is specified with a file name as a digital data file. The file may be prepared in advance or may be input through the image input device 2. When the image input device 2 is used, digital data obtained through the image input device 2 may be transferred to the server 7 automatically. A file format of the face data 3 may be any format the program can understand. If Internet is used, it is common to use a jpeg or gif file.

In FIG. 31, a block 44 is an input field for inputting a file name of an image and a block 45 is a “SEND” button for starting transfer of the face data 3. When the “SEND” button 45 is pressed the face data 3 specified in the input field 44 is transferred from the terminal 1 to the network 9 through the server 7. At the transfer process, the face data 3 is compressed and encoded by the data converting section 10 in the terminal 1 and the face data 3 is extended and decoded by the data converting section 8 in the server 7, as necessary. Then, the face data 3 is reproduced and saved in the data memory section 11 temporally. Thus, private information hardly leaks even when the data leaks.

The program section 6 in the server 7 extracts based on transferred face data 3 a changing part including a feature part and an absorbing part. The extraction desirably can be done automatically within the program 6. However, if the processing takes a long time or accurate extraction is not possible, the feature part may be specified by the changing person.

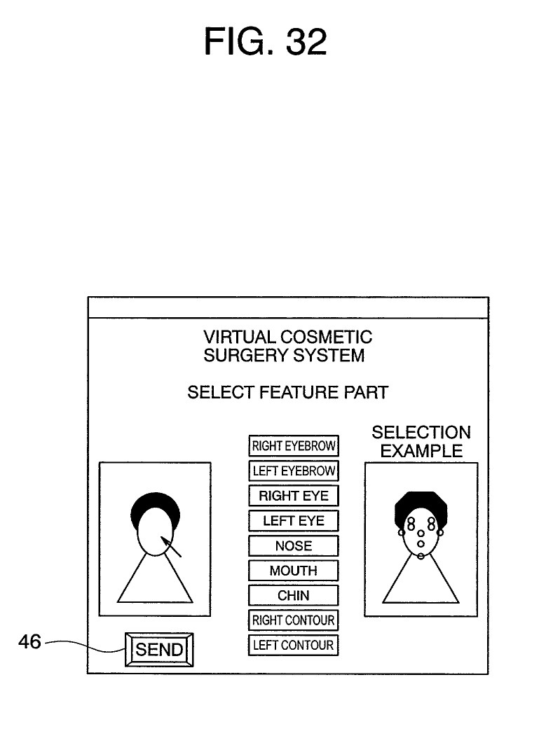

FIG. 32 shows one example of a screen where the changing person is asked to specify a feature part. FIG. 32 shows a case where the changing person is asked to specify nine points including eyebrows and eyes. When the feature part is specified by the changing person, supplemental information is desirably given to the changing person so as to advice the changing person to specify the nearest point required by the program 6 as much as possible.

In FIG. 32, a “SEND” button 46 is used for transferring a feature point. Once the “SEND” button 46 is pressed, a specified feature point is transferred from the terminal 1 to the server 7 through the network 9. At the transfer process, the data is compressed and encoded by the data converting section 10 in the terminal 1 and the data is extended and decoded by the data converting section 8 in the server 7, as necessary. Then, the face data 3 is reproduced and saved in the data memory section 11 temporally. Thus, private information hardly leaks even when the data leaks.

Next, the program section 6 asks change information to the changing person. FIG. 14 shows one example of a changing part select screen. In FIG. 14, a block 24 is a “changing part specify” button and having a plurality of buttons including “EYEBROW” and “EYE” buttons for respective parts. Preferably, an “ALL” button indicating total change is provided for changing all of each part data based on a certain rule so that the changing person can carry out total make-up easily. Further, a “CHANGE RESET” button is desirably provided for changing all of changes back to a first image.

In FIG. 14, blocks 25a and 25b are display areas of changing person face data. The display area 25a always displays face data 3 before change. The display area 25b is where a change result is reflected. The change result may be displayed on the display area 25b for every specification of change on each part. Alternatively, if a “CHANGE DECIDED” button 26 is prepared, all of changes may be performed at one time when the “CHANGE DECIDED” button 26 is pressed, and then the change result may be displayed. Face data may be displayed only with an image after change. However, it is desirable that both face data before and after change are displayed in parallel so that the changing person can realize effects by the change easily.

Further, in FIG. 14, a block 27 is a “SAVE” button of a change image. The changing person selects a part that he/she needs to change on his/her face and presses corresponding buttons of “changing part specify” button 24. Then, a decide screen for an amount of changing a select part is displayed. The changing amount decide screen may be displayed together within the same window. Alternatively, another window may be created to display the screen.

FIG. 15 shows one example of a decide screen of an amount of changing an eye. The changing person inputs an angle, a longitudinal extension ratio and a lateral extension ratio in input regions 28a, 28b and 28c, respectively, in order to determine a changing amount and then press a “CHANGE DECIDED” button 29. Similarly, the changing person decides changing amounts for parts which can be changed such as nose and mouth.

Change information is transferred from the terminal 1 to the server 7 through the network 9 for every completion of change input for each part or when all of the change information is completed and the “CHANGE DECIDED” button 29 is pressed. At the transfer process, the data is compressed and encoded by the data converting section 10 in the terminal 1 and the data is extended and decoded by the data converting section 8 in the server 7 for reproduction, as necessary. Thus, private information hardly leaks even when the data leaks.

Next, the program 6 changes an image based on changing information. The changing method is the same as the one according to the first embodiment. The changed image is transferred from the server 7 to the terminal 1 through the network 9 and displayed in the display area 25b. Further, a copy of the changed image is stored in the data memory section 11 temporally. At the transfer process, the data is compressed and encoded by the data converting section 8 in the server 7 and the data is extended and decoded by the data converting section 10 in the terminal 1 for reproduction, as necessary. Thus, private information hardly leaks even when the data leaks. However, if the changing parson is not satisfied with a changing result, the change can be continued or changed immediately. Operation for that is the same as the first changing operation.

Once the changing person completes changes, the “SAVE” button 27 is pressed if he/she needs to save the image after the changes on the display area 25b. FIG. 23 shows one example of a changed image saving screen. In FIG. 23, a block 33 is an input field for inputting a storage place. A block 34 is an input field for selectively input a saving file format, and a block 35 is a “SAVE” button for starting saving.

The changing person selects and inputs a saving place and a saving file format in the input fields 33 and 34 and then presses the “SAVE” button 35. Then, saving the changed image is completed. The saving file format may be fixed to a general file format such as jpeg. However, it is desirable that a plurality of general file formats can be selected in view of convenience of the changing person.

In each of screens, it is possible that a “HELP” button, not shown, for supplying information aiding operations by the changing person is provided so that the changing person can be provided with information helping changing person's operations in each of screens by pressing the button.

Charging may be performed when information is exchanged between the terminal 1 and the server 7. FIG. 26 shows one example of a charge confirmation screen. In FIG. 26, blocks 41 are input fields for inputting a name of the changing person and charging information such as credit card information. The changing person inputs information used for being charged such as his/her name and/or credit card number. Types of the information are not limited in particular, but, at least, must be information by which the changing person can be identified and it can be confirmed if the changing person will pay for the charge.

In FIG. 26, a block 42 is a charge confirmation button. When the changing person presses a “YES” button, he/she is charged for a chargeable transaction. On the other hand, when the changing person presses a “NO” button, he/she cannot perform the chargeable transaction.

When the changing person inputs the charging information and presses the “YES” button of the charge confirmation button 42, the charging information is transferred from the terminal 1 to the server 7. At the transfer process, the data is compressed and encoded by the data converting section 10 in the terminal 1 and the data is extended and decoded by the data converting section 8 in the server 7 for reproduction, as necessary. Thus, private information hardly leaks even when the data leaks.

At the charging process, an arrangement is desirable that the chargeable information can be identified by the changing person easily, and when he/she presses a button for requesting the chargeable information, that is when the “NO” button of the charge confirmation button 42 is pressed, the changing person is informed that the information is not available because it is chargeable while when the “YES” button is pressed, the changing person is informed of that he/she is charged in return for obtaining the chargeable information and the charged amount.

FIG. 27 shows one example of a charging screen in the present system. The screen is displayed only when the changing person uses the chargeable information. The changing person checks the charge and if he/she wishes to pay, he/she presses “YES”. On the other hand, if he/she does not have an intention to pay, he/she presses the “NO” button. When the “YES” button is pressed, the screen goes to a chargeable information screen while when the “NO” button is pressed, the screen moves to a screen before selecting the chargeable information.

According to the arrangement as above, the changing person can obtain an image where a face is changed in natural looking way partially by operating the virtual cosmetic surgery system.

In the third embodiment, encoding/decoding processing is performed on data when the data is transferred through the network 9. In that case, any method can be used for encoding. However, changing the encoding method to another method for a certain period of time can prevent information leaks.

Further, when data is transferred from the terminal 1 to the server 7 or from the server 7 to the terminal 1, the load on the private line or Internet can be reduced by compressing data, which provides the changing person comfortable operation.

What is claimed is:

1. A virtual cosmetic surgery system, comprising:
face image input means for inputting face image data;
change information input means for inputting change information of said face image data; and
change processing means for extracting from said face image data based on said change information a feature part selected as a part to be changed and an absorbing part surrounding said feature part, changing said feature part in predetermined manner and changing said absorbing part so as to absorb a gap with respect to the periphery caused by a change on said feature part.

2. A virtual cosmetic surgery system according to claim 1 wherein said change information input means inputs a changing part in said face image data and its changing amount as said change information.

3. A virtual cosmetic surgery system, comprising:
a server for storing a virtual cosmetic surgery program;
face image data input means for inputting face image data;
change information input means for inputting change information of said face image data; and
a processing terminal for executing said virtual cosmetic surgery program,
wherein said processing terminal extracts from said face image data based on said change information a feature part selected as a part to be changed and an absorbing part surrounding said feature part, changes said feature part in predetermined manner and changes said absorbing part so as to absorb a gap with respect to the periphery caused by a change on said feature part.

4. A virtual cosmetic surgery system according to claim 3, wherein said processing terminal performs a predetermined changing processing such as extension and/or rotation on said feature part of said changing part and performs changing processing on said absorbing part of said changing part so as to maintain the continuity of images in said feature part and its peripheral part in accordance with said feature part processing.

5. A virtual cosmetic surgery system, comprising:
face image input means for inputting face image data;
change information input means for inputting change information on said face image data;
a processing terminal for sending said face image data input by said face image input means and said change information input means and its change information; and
a server for receiving through network said face image data and its change information sent by said processing terminal,
wherein said server extracts from said face image data based on said change information a feature part selected to be changed and an absorbing part surrounding said feature part, changes said feature part in predetermined manner and changes said absorbing part so as a part to absorb a gap with respect to the periphery caused by a change of said feature part.

6. A virtual cosmetic surgery system according to claim 5, wherein said server performs a predetermined changing processing such as extension and/or rotation on said feature part of said changing part and performs changing processing on said absorbing part of said changing part so as to maintain the continuity of images in said feature part and its peripheral part in accordance with said feature part processing.

7. A virtual cosmetic surgery system according to claim 2 wherein said server has a charging processing section for performing charging in predetermined manner when data is exchanged through said network.

8. A virtual cosmetic surgery system according to claim 2, wherein:
said processing terminal has a first data compressing/extending section for compressing/extending data exchanged through said network; and
said server has a second data compressing/extending section for compressing/extending data exchanged through said network.

9. A virtual cosmetic surgery system according to claim 2, wherein:
said processing terminal has a first data encoding/decoding section for encoding/decoding data exchanged through said network; and
said server has a second data encoding/decoding section for encoding/decoding data exchanged through said network.

10. A virtual cosmetic surgery method for extracting from said face image data a feature part selected as a part to be changed and an absorbing part surrounding said feature part, changing said feature part in predetermined manner and changing said absorbing part so as to absorb a gap with respect to the periphery caused by a change on said feature part.

11. A virtual cosmetic surgery method according to claim 10, wherein, when a part to be changed such as eye and nose are specified with a point, a rectangular area including this point is extracted as said feature part and a rectangular area surrounding said feature part is extracted as said absorbing part.

12. A virtual cosmetic surgery method according to claim 10, wherein said absorbing part smoothes a distortion caused by a change on said feature part through coordinate conversion by using two-dimensional interpolation.

13. A virtual cosmetic surgery system according to claim 4, wherein said server has a charging processing section for performing charging in predetermined manner when data is exchanged through said network.

14. A virtual cosmetic surgery system according to claim 4, wherein:
said processing terminal has a first data compressing/extending section for compressing/extending data exchanged through said network; and
said server has a second data compressing/extending section for compressing/extending data exchanged through said network.

15. A virtual cosmetic surgery system according to claim 4, wherein:
said terminal has a first data encoding/decoding section for encoding/decoding data exchanged through said network; and
said server has a second data encoding/decoding section for encoding/decoding data exchanged through said network.

16. A virtual cosmetic surgery method according to claim 11, wherein said absorbing part smoothes a distortion caused by a change on said feature part through coordinate conversion by using two-dimensional interpolation.
